(19) United States
(12) Patent Application Publication
(10) Pub. No.: US 2003/0169733 A1
(43) Pub. Date: Sep. 11, 2003

(54) Asynchronous input/output interface protocol

(76) Inventors: Mark J. Gurkowski, Longmont, CO (US); Stan M. Keeler, Longmont, CO (US); Lane W. Lee, Lafayette, CO (US)

Correspondence Address: Alan MacPherson, MacPherson Kwok Chen and Heid LLP, 2001 Gateway Place Suite 195, San Jose, CA, 95110, US

(21) Appl. No.: 10/290,066

(22) Filed: Nov. 6, 2002

Related U.S. Application Data
(63) Continuation of application No. 09/539,842, filed on Mar. 31, 2000, now abandoned.

(51) Int. Cl. H04Q 11/00

(52) U.S. Cl. 370/382

(57) ABSTRACT

An interface protocol for transmitting variable-sized packets between a host system and a storage device. The protocol supports a plurality of signals for transmitting data between the host system and the storage device. One or more address signals indicate whether the packet includes command, data, or status information. An enable signal indicates when the packets may be transmitted to and from the storage device. Read and write strobe signals are also included to allow the host to request data from and transmit data to the storage device. The protocol includes an extensible command set which includes a function code, one or more interrupt requests, and signals to indicate when the storage device is busy, when the storage device is ready to transfer data, when the storage device is ready to receive bytes from a command packet, when the storage device is ready to receive or transmit a data block, and when the storage device is ready to transmit status bytes.

### BACKGROUND OF THE INVENTION

1. Field of the Invention

This invention relates generally to communication interface protocols. More specifically, this invention relates to a data bus communication interface protocol that handles asynchronous events initiated by either a host system or a peripheral device during active command processing.

2. Description of the Related Art

Downloading copies of movies, music recordings, books, and other media via computer networks such as the Internet, is becoming increasingly popular. There are also an increasing number of different types and sizes of devices available to consumers for accessing the downloaded information. One concern, however, is protecting the media from unauthorized access, copying, and distribution.

Devices used by consumers for playing music, watching movies, and reading print media range from home theatre systems to highly portable palmtop devices. Accordingly, there is a need to provide a storage device and storage medium that is compact and portable, yet capable of storing and transmitting large amounts of data for real-time recording and playback. The storage device must also interface with a wide variety of hosts such as personal computer systems, televisions, audio systems, and portable music players. Further, it is important for the storage device to protect content on the storage medium from unauthorized duplication.

### SUMMARY OF THE INVENTION

The present invention provides an asynchronous interface protocol for transmitting variable-sized packets between a host system and a storage device. The protocol supports a parallel data bus for transmitting data between the host system and the storage device. A plurality of address signals indicate whether the packet includes command, data, or status information. An enable signal indicates when the packets may be transmitted to and from the storage device. Read and write strobe signals are also included to allow the host to request data from and transmit data to the storage device.

The protocol includes an extensible command set which includes a function code, one or more interrupt requests, and signals to indicate when the storage device is busy, when the storage device is ready to transfer data, when the storage device is ready to receive bytes from a command packet, when the storage device is ready to receive or transmit a data block, and when the storage device is ready to transmit status bytes.

The interface protocol is a relatively simple, low-level interface that supports a sophisticated, variable-length packet-based, extensible command set, and asynchronous events. This offers advantages not found in prior art interfaces, where the simpler interfaces are not typically packet-based, nor do they support commands other than read and write input and output.

The interface protocol of the present invention enables various types of host systems to communicate with various types of storage devices without knowledge of the type of storage device being used. The interface protocol also supports data transfers of various sizes of blocks, up to the maximum number of bytes per packet the storage device and host systems are capable of handling, thereby potentially reducing the number of packets to transmit and speeding up the data transfer process.

The foregoing has outlined rather broadly the objects, features, and technical advantages of the present invention so that the detailed description of the invention that follows may be better understood.

### BRIEF DESCRIPTION OF THE DRAWINGS

FIG. 1 is a diagram illustrating a general architecture of a host system coupled to a data storage device with which the present invention may be utilized.

FIG. 2 is a diagram of a file system with which the present invention may be utilized.

FIG. 3 is a time history diagram showing one embodiment of a sequence of signals transmitted between a host system and a storage device.

FIG. 4 is a diagram showing state transitions during interface protocol command execution in accordance with one embodiment of the present invention.

FIG. 5 is a diagram showing timing during interface protocol command execution in accordance with one embodiment of the present invention.

### DETAILED DESCRIPTION

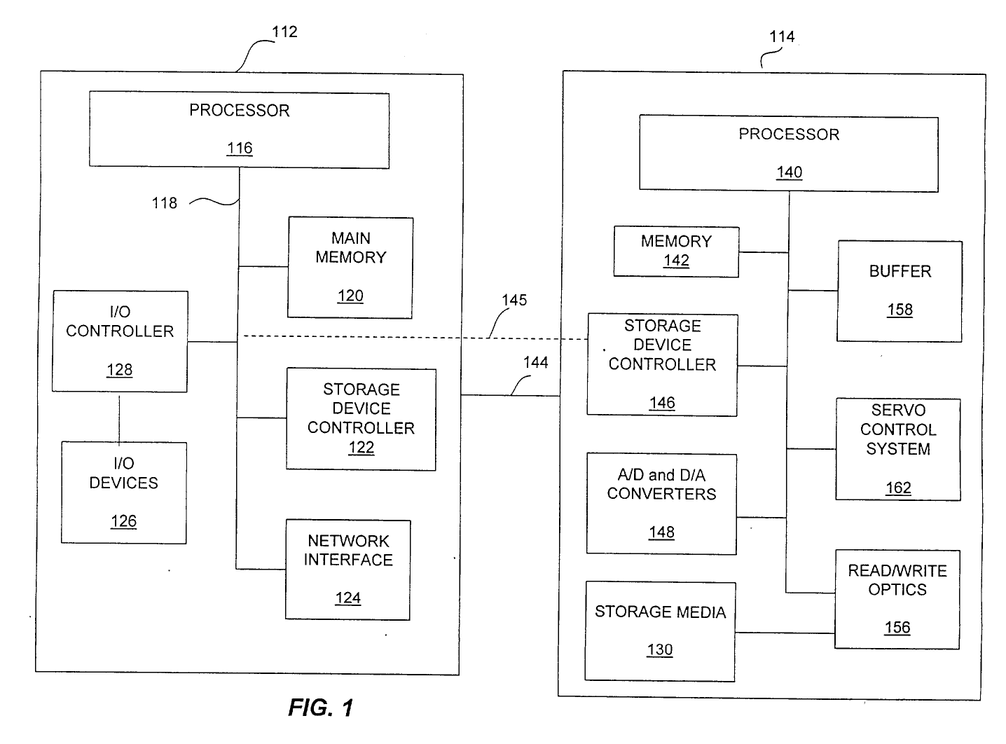

FIG. 1 shows a block diagram of components comprising one example of host system 112 and storage device 114 with which the present invention may be utilized. In host system 112, one or more processors 116 are connected by host bus 118 to main memory 120, storage device controller 122, network interface 124, and input/output (I/O) devices 126, connected via I/O controller 128. Those skilled in the art will appreciate that host system 112 encompasses a variety of systems that are capable of processing information in digital format including, for example, televisions, stereo systems, handheld audio and video players, portable computers, personal digital assistants, and other devices that include information processing components.

With the present invention, information may be pre-loaded on storage media 130, or a user may download information from a source, such as the Internet, using one type of host system 112. Storage media 130 containing the downloaded information may then be removed from storage device 114 and used with another compatible storage device 114 capable of reading and/or writing to storage media 130. Storage device 114 may be embedded in host system 112 or plugged in as an external peripheral device. Accordingly, host system 112 includes the appropriate hardware and software components to transfer, encrypt/decrypt, compress/decompress, receive, record, and/or playback audio, video, and/or textual data, depending on the functionality included in host system 112. Such components may include audio and video controllers, peripheral devices such as audio system speakers, a visual display, keyboards, mouse-type input devices, modems, facsimile devices, television cards, voice recognition devices, and electronic pen devices.

Storage device 114 includes processor 140 coupled to memory 142 which may be one or a combination of several types of memory devices including static random access memory (SRAM), flash memory, or dynamic random access memory (DRAM). Storage device 114 is coupled to host system 112 via bus 144. Alternatively, storage device 114 may be coupled directly to host bus 118 via bus 145, and the functions performed by storage device controller 122 may be performed in processor 116, or another component of host system 112.

Storage device controller 146 receives input from host system 112 and transfers output to host system 112. Processor 140 includes operating system instructions to control the flow of data in storage device 114. In one embodiment, bus 144 is an asynchronous, eight-bit data bus capable of accessing file system objects using a single identifier between host system 112 and storage device 114. A communication protocol for bus 144 is described herein below.

In one embodiment, data is transmitted to and from storage media 130 via read/write optics 156. In other embodiments, data is transmitted to and from storage media 130 via read/write electronics (not shown). The data may be converted from analog to digital format, or from digital to analog format, in converters 148. For example, analog data signals from read optics 156 are converted to a digital signal for input to buffer 158. Likewise, digital data is converted from digital to analog signals in converter 148 for input to write optics 156. Buffer 158 temporarily stores the data until it is requested by controller 146.

Servo control system 162 provides control signals for actuators, focus, and spin drivers that control movement of the storage media 130.

One skilled in the art will recognize that the foregoing components and devices are used as examples for sake of conceptual clarity and that various configuration modifications are common. For example, although host system 112 is shown to contain only a single main processor 116, those skilled in the art will appreciate that the present invention may be practiced using a computer system that has multiple processors. In addition, the controllers that are used in the preferred embodiment may include separate, fully programmed microprocessors that are used to off-load computationally intensive processing from processor 116, or may include input/output (I/O) adapters to perform similar functions. In general, use of any specific example herein is also intended to be representative of its class and the non-inclusion of such specific devices in the foregoing list should not be taken as indicating that limitation is desired.

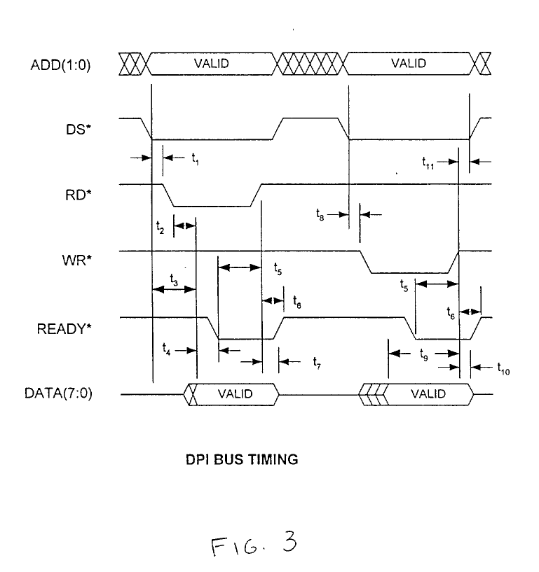

Referring now to FIG. 2, one embodiment of a file system 200 that may utilize the present invention for an interface protocol for data bus 144 is shown. Host system 112 includes file system manager 210, translator 212, and one or more device drivers 214. The number and type of device drivers 214 included depends on the types of storage devices that are interfaced with host system 112. File system 200 provides access to a fully hierarchical directory and file structure in storage devices 114, with individual files having full read and write capabilities. File system manager 210 regards storage device 114 as a volume containing a set of files and directories. These files and directories may be accessed by name or other identifier associated with that object. In one embodiment, file system manager 210 receives commands from application programs 216 to create, rename, or delete files and directories, and to read or write data to files. File system manager 210 also receives information regarding data to transmit or receive from storage device 114. This information includes the storage device and the name of the file or directory to be accessed by host system 112.

In the prior art, file and directory manipulation commands typically required full pathnames for identification. One feature of file system 200 is that file system manager 210 parses the pathnames of directories and files, and passes only the name of the directory or file to translator 212. Translator 212 converts the names to unique identifiers that are used by file system manager 210 on subsequent accesses. Translator 212 also constructs packets that include information such as file and directory identifiers to be accessed, and the commands to be performed. The packets are transmitted to hardware device driver 214, as required, depending on the commands issued by application programs 116. File system 200 is further described in copending U.S. Patent Application Serial No. ______, entitled “File System Management Embedded In A Storage Device” which was filed on the same day as the present invention, is assigned to the same assignee, and is hereby incorporated by reference.

Data Bus Signals

The present invention provides an interface protocol for accessing data bus 144 and storage device controller 146 that may be utilized to transfer data between host system 112 and storage device 114. The following definitions apply to signals transmitted to and from data bus 144 and storage device controller 146:

TABLE 1

| | |
|---|---|
| Active High | The signal's true state is the high logic level. |
| Active Low | The signal's true state is the low logic level. |
| Asserted | The signal is driven by an active circuit to its true state. |
| Negated | The signal is driven by an active circuit to its false state. |
| Released | The signal is not actively driven to any state. |
| Set | The bit has a logical 1 value. |
| Cleared | The bit has a logical 0 value. |

Data bus 144 and storage device controller 146 connect storage device 114 to any host system 112. In one embodiment, data bus 144 includes an 8 bit bi-directional data bus (DATA), read and write strobe controls (RD* and WR*), a chip enable and two address lines (DS*, ADD1 and ADD0) that are driven by host system 112, and a ready signal (READY*) and interrupt signal (IRQ) that are driven by storage device 114. The following sections describe these signals.

DATA[7:0]

During host system 112 write cycles, data bus 144 transmits data from host system 112 to storage device 114. Storage device 114 latches the data from host system 112 into its internal registers on the rising edge of WR* if the DS* signal is active. During host read cycles, data bus 144 carries data from storage device 114 to host system 112. Storage device 114 drives data bus 144 while the RD* signal and the DS* are both active. The location of the data register within storage controller 146 is selected via the ADD0 and ADD1 signals. The data is not valid until the READY* signal is low.

DS*

The DS* signal is active with low input. When this signal is asserted, storage device 114 responds to assertion of the RD* or the WR* signal. When this signal is negated, storage device 114 does not respond to the assertion of RD* or WR*.

RD*

The RD* signal is active with low input. When this signal is asserted and DS* is asserted, storage device 114 drives data bus 144. The ADD0 and ADD1 input signals select the source register for the data.

WR*

The WR* signal is active with low input. When this signal is asserted and DS* is asserted, storage device 114 latches data into one of its internal registers on the rising edge of this signal. The data latched is received via data bus 144. The ADD0 and ADD1 input signals select the specific register that receives the data.

READY*

The READY* signal is output by storage device 114, which negates this signal (high) when the selected internal data register is not ready to receive data from or send data to host system 112, when DS* is asserted, and either RD* or RW* is asserted. Storage device 114 then asserts this signal (low) when data is ready.

ADD0

The ADD0 signal is active with high input. Host system 112 asserts this signal in conjunction with ADD1 to select a register within storage device controller 146, as shown in table 4 below, as the source of a read access (RD* asserted), or the destination of a write access (WR* asserted). This signal must remain asserted during the entire assertion of RD* or WR*.

ADD1

The ADD1 signal is active with high input. Host system 112 asserts this signal in conjunction with ADD0 to select a register within the storage device controller 146, as shown in table 4 below, as the source of a read access (RD* asserted), or the destination of a write access (WR* asserted). This signal must remain asserted during the entire assertion of RD* or WR*.

IRQ*

The IRQ* signal is active with low output. Storage device 114 asserts this interrupt signal to notify host system 112 that a significant event occurred in storage device 114. Host system 112 responds by reading the status register to determine the reason for the interrupt.

In one embodiment, the data transfer rates are approximately twenty (20) megabytes per second for cable lengths up to three (3) inches and fifteen (15) megabytes per second for cable lengths greater than three (3) inches. Various types of connectors known in the art can be used to connect data bus 144 between controller 122 in host system 112 and controller 146 in storage device 114. The following table shows one example of connector pin assignments for the signals:

TABLE 2

| | | |
|---|---|---|
| Signal name | Conductor | Signal name |

| | | | |
|---|---|---|---|
| Open | 1 | 2 | Ground |
| DS* | 3 | 4 | ADD1 |
| RD* | 5 | 6 | ADD0 |
| READY* | 7 | 8 | WR* |
| Open | 9 | 10 | IRQ* |
| Open | 11 | 12 | DATA 0 |
| DATA 7 | 13 | 14 | DATA 1 |
| DATA 6 | 15 | 16 | DATA 2 |
| DATA 5 | 17 | 18 | DATA 3 |
| DATA 4 | 19 | 20 | Ground |

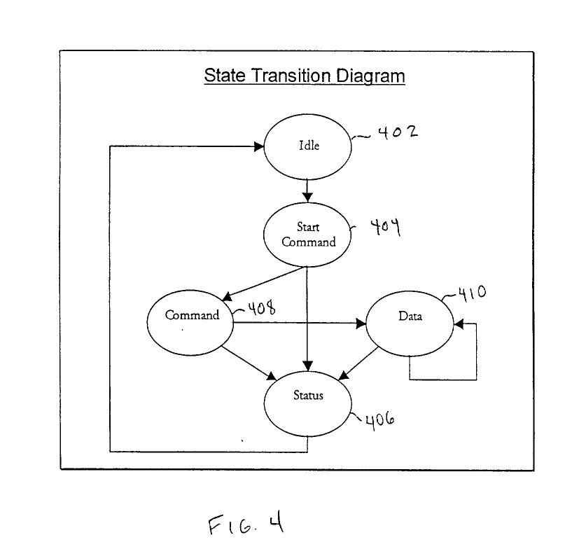

FIG. 3 shows one example of signal time histories for read and write operations using data bus 144. It should be noted that other timing sequences may be implemented, depending on characteristics of host system 112. To perform a read operation, time periods t₁ through t₄ are required for the chip enable signal DS to be asserted, for the READ signal to be asserted, for the DATA[7:0] signals to be valid, and for storage device 114 to output the READY* signal. Once the data is read during time period t₅, the READY* signal transitions from active to inactive during time period t₆.

An example of a timing sequence for a write operation is shown during time periods t₈ through t₁₁. To perform a write operation, time period t₈ through the beginning of t₉ are required for the chip enable signal DS to be asserted (low), for the WRITE signal to be asserted (low), and for the DATA[7:01] signals to be valid. Storage device 114 outputs the READY* signal at the beginning of time period t₅. Once the data is written during time period t₅, the READY* signal transitions from active to inactive during time period t₆. The following table provides details for events during time periods t₁ through t₁₁, where time unit ns represents nanoseconds.

TABLE 3

| Time | Description | Explanation | Minimum | Maximum | Units |
|---|---|---|---|---|---|
| t₁ | DS read | ADD, DS setup to | 5 | | ns |
| | setup | RD active | | | |
| t₂ | RD delay | RD active to DATA | | 30 | ns |
| | | valid | | | |
| t₃ | ADD read | ADD, DS setup to | | 40 | ns |
| | setup | DATA valid during | | | |
| | | read. | | | |
| t₄ | DATA setup | DATA setup to | 0 | | ns |
| | to READY* | READY* active | | | |
| | | during read. | | | |
| t₅ | READY* to | READY* active to | 0 | | ns |
| | RD, WR | RD or WR inactive | | | |
| t₆ | READY* | READY* inactive | | 15 | ns |
| | delay | delay from RD, WR | | | |
| | | inactive | | | |
| t₇ | DATA float | RD inactive to | | 10 | ns |
| | | DATA float | | | |
| t₈ | DS write | ADD, DS setup to | 5 | | ns |
| | setup | WR active | | | |
| t₉ | Write DATA | DATA setup to WR | 20 | | ns |
| | setup | inactive | | | |
| t₁₀ | Write DATA | DATA hold from | 0 | | ns |
| | hold | WR inactive | | | |
| t₁₁ | DS write | ADD, DS hold from | 0 | | ns |
| | hold | WR inactive | | | |

Host system 112 communicates with storage device 114 using a set of registers. Host system 112 selects the register to access by asserting or negating the ADD0 and ADD1 signals, according to the following table.

TABLE 4

| ADD1 | ADD0 | Read/Write | Register |
|---|---|---|---|
| 0 | 0 | R/W | Data register |
| 0 | 1 | R/W | Byte Count register |
| 1 | 0 | W | Control register |
| 1 | 0 | R | Status register |
| 1 | 1 | — | Reserved |

Control Register

Control register is written by host system 112 and holds the Function Controls and the Interface Interrupt Enable/Disable values. The register is read by storage device 114. One example of bit definitions are shown in the following table.

TABLE 5

| Bit | Bit Name | Description |
|---|---|---|
| 7 | Reserved | Write to 0. |
| 6:4 | FUNCTION | 000 = No Function. Writing this value has no effect. |
| | CODE | 001 = Start Command. Writing this value causes |
| | | storage device 114 to enter Command phase and |
| | | begin the command protocol. |
| | | 010 = Abort. Writing this value causes storage |
| | | device 114 to abort any command in progress, clear |
| | | BUSY and DATA, and return to its idle state. All |
| | | data transferred to storage device 114 on a write |
| | | will be written. |
| | | 011 = Reset Byte Count Pointer. Writing this |
| | | value resets the Byte Count address pointer so |
| | | that the next host access reads or writes bits 0:7. |
| | | 100 = Enable Power-On Signature. Writing this |
| | | value enables the Power-On detection signature |
| | | AND aborts active commands |
| | | 101 = Acknowledge Attention Interrupt. Writing |
| | | this value clears the Attention Interrupt bit in the |
| | | Status register. |
| | | 110 = Acknowledge Command/Data/Status |
| | | Interrupt. Writing this value clears the Command/ |
| | | Data/Status Interrupt bit in the Status register. |
| | | 111 = Acknowledge All Interrupts. Writing this |
| | | value clears both the Command/Data/Status |
| | | Interrupt and Attention Interrupt bits in the Status |
| | | register. |
| 3 | CMD IRQ | Enables storage device 114 to assert DPI_IRQ* |
| | ENABLE | during Command phase. When 1, storage device |
| | | 114 asserts DPI_IRQ* when: |
| | | Command/Data/Status Interrupt = 1 AND |
| | | Control/Data* = 1 AND |
| | | Input/Output* = 0 |
| | | in the Status register. |
| 2 | DATA IRQ | Enables storage device 114 to assert DPI_IRQ* |
| | ENABLE | during Read Data or Write Data phases. When 1, |
| | | storage device 114 asserts DPI_IRQ* when: |
| | | Command/Data/Status Interrupt = 1 AND |
| | | Control/Data* = 0 |
| | | in the Status register. |
| 1 | STATUS IRQ | Enables storage device 114 to assert DPI_IRQ* |
| | ENABLE | during Status phase. When 1, storage device 114 |
| | | asserts DPI_IRQ* when: |
| | | Command/Data/Status Interrupt = 1 AND |
| | | Control/Data* = 1 AND |
| | | Input/Output* = 1 |
| | | in the Status register. |
| 0 | ATTENTION | When 1, storage device 114 asserts DPI_IRQ* |
| | IRQ ENABLE | when: |
| | | Attention Interrupt = 1 |
| | | in the Status register. |

When host system 112 writes this register with the function code Start Command, the BUSY bit in the status register is set. The BUSY bit in the Status Register stays set throughout the command until Status phase for the command completes. If host system 112 writes the Control register with the Start Command function code while BUSY is set, it has no effect on storage device 114.

The Abort function code's purpose is to force storage device 114 to abort its current command. It has an effect on storage device 114 only when BUSY is set. If host system 112 writes the Control register with the Abort function code while BUSY is clear, it has no effect on storage device 114.

All other function codes have the desired effect with BUSY set or clear.

Status Register

The status register communicates state information and interrupt reason information. This register is read-only to host system 112, and read/write to storage device 114. The bit definitions are shown in the following table.

TABLE 6

| Bit | Bit Name | Description |
|---|---|---|
| 7 | BUSY | When 1, indicates that storage device 114 is |
| | | currently performing power on initialization, or |
| | | processing a command or an abort function. |
| | | Storage device 114 sets this bit when |
| | | Power is first applied to storage device 114, |
| | | OR |
| | | Host system 112 writes the Start Command |
| | | function code to the Control Register |
| | | Storage device 114 clears this bit when |
| | | It has completed its power on initialization, |
| | | OR |
| | | It has completed processing a command, OR |
| | | It has completed processing an Abort |
| | | operation. |
| 6 | DATA | When 1, indicates storage device 114 is prepared |
| | | to transfer command, data, or ending status |
| | | information to or from host system 112 via the |
| | | Data Register. |
| | | When 0, no data transfer is ready. |
| 5 | CMD/DATA/ | Storage device 114 sets this bit each time it sets |
| | STATUS IRQ | Data Request during the processing of a |
| | | command: |
| | | When it is prepared to receive command |
| | | packet bytes, OR |
| | | When it is prepared to receive or transmit the |
| | | next data block, OR |
| | | When it is prepared to transmit ending status |
| | | bytes. |
| | | Host system 112 clears this bit by acknowledging |
| | | the interrupt via the Control Register. |
| 4 | ATTENTION | Storage device 114 sets this bit when it determines |
| | IRQ | that an asynchronous event requires the attention of |
| | | host system 112. |
| | | Host system 112 clears this bit by acknowledging |
| | | the interrupt via the Control Register. |
| | | After acknowledging the interrupt, host system 112 |
| | | may abort or complete the command in progress (if |
| | | any), then issue a command to determine the cause |
| | | of the Attention interrupt. |
| 3:2 | Reserved | Read as 0. |
| 1 | RD/WR* | When 1, indicates transfer direction is from device |
| | | to host. |
| | | When 0, indicates transfer direction is from host to |
| | | device. |
| 0 | CONTROL/ | Selects whether control information or data is to be |
| | DATA* | transferred. |
| | | When 1, and RD/WR* = 1, indicates status bytes |
| | | are to be transferred from storage device 114 to host |
| | | system 112 (Status phase). |
| | | When 1, and RD/WR* = 0, indicates command |
| | | packet bytes are to be transferred from host system |
| | | 112 to storage device 114 (Command phase). |
| | | When 0, and RD/WR* = 1, indicates data is to be |
| | | transferred from storage device 114 to host system |
| | | 112 (Read Data phase). |
| | | When 0, and RD/WR* = 0, indicates data is to be |
| | | transferred from host system 112 to storage device |
| | | 114 (Write Data phase). |
| | | The RD/WR* and CONTROL/DATA * bits are |
| | | valid only when DATA is set. |

Byte Count Register

The byte count register contains the byte count for the next Command, Data, or Status phase transfer. Host system 112 accesses this 16-bit register by two consecutive 8-bit read or write operations. Host system 112 is required to read or write both bytes when accessing this register. The first cycle accesses bits 7:0; the second accesses bits 15:8. Subsequent read or write operations flip back to 7:0, then 15:8.

Prior to writing the Start Command function to the Control Register, host system 112 writes this register with the length in bytes of the command packet it wishes to transmit.

Prior to setting the Command/Data/Status Interrupt bit in the Status Register, storage device 114 writes this register with the length in bytes of the data transfer it wishes to initiate. After recognizing the Command/Data/Status Interrupt, host system 112 reads this register to determine the length of the transfer.

Host system 112 may write to this register only when the BUSY bit in the Status register is clear.

This register returns valid information only when the DATA bit in the Status register is set. If host system 112 reads this register while DATA is clear, the READY* signal will negate. One exception to this rule is during power-on detection.

Data Register

Host system 112 writes to this register to transfer data to storage device 114 during Command and Data Out phases.

Host system 112 reads this register to transfer data from storage device 114 during Status and Data In phases.

Host read/write accesses to this register when the DATA bit in the Status register is clear causes the READY* signal to negate, holding off the access. One exception to this rule is during power on detection.

Interface Protocol Command Processing

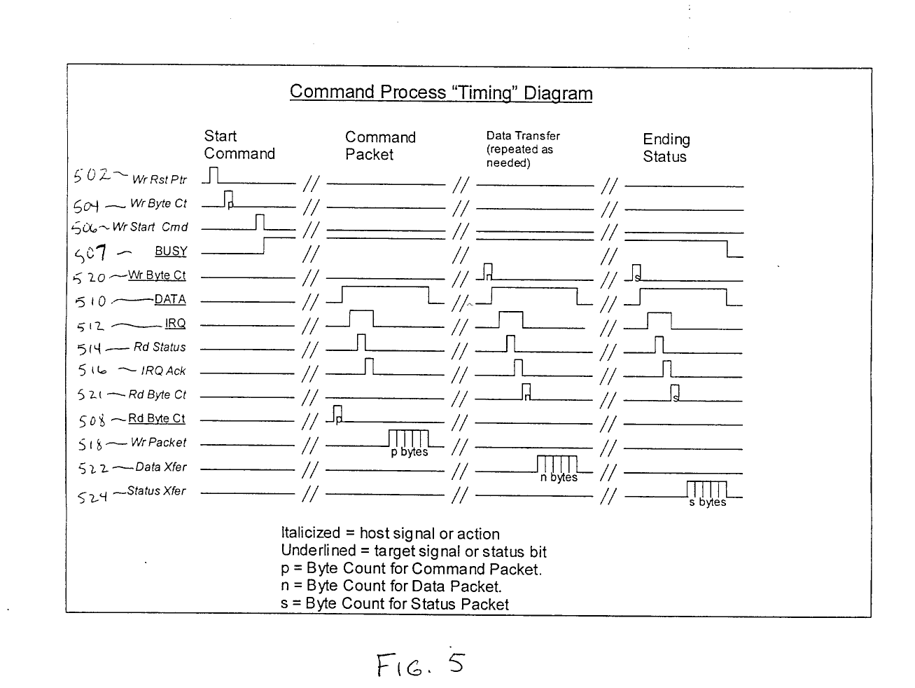

FIG. 4 shows a state diagram of one embodiment of processing interface protocol commands. From idle state 402, host system 112 queries whether the BUSY bit in the Status register is clear before attempting to initiate a command. If storage device 114 has BUSY set, host system 112 must issue the Abort function, then wait for BUSY to clear, before initiating the command.

Once BUSY is clear, the state transitions to start command state 404. FIG. 5 shows an example of a timing diagram for the events that occur during command processing. It is important to note that different timing sequences may be implemented, with FIG. 5 showing just one possibility. Referring now to FIGS. 4 and 5, to initiate a command, host system 112 transmits the Reset Byte Count Pointer function code to the Control register to ensure proper address alignment (process 502). Host system 112 then transmits the command packet size to the Byte Count register (process 504), and the Start Command function code and the desired IRQ Enable bit settings to the Control register (process 506). The command is initiated upon completion of the write to the Control register.

Storage device 114 sets BUSY in the Status register as soon as the Start Command function code has been written (process 507). BUSY remains set for the entire execution of the command. Storage device 114 reads the command packet size from the Byte Count registers (process 508). If the size is zero, or greater than the maximum command packet size supported, storage device 114 proceeds immediately to Status state 406 to indicate the error. Otherwise, storage device 114 enters Command state 408.

To initiate Command state 408, storage device 114 sets CONTROL/DATA* and clears RD/WR* in the Status register. It then sets DATA and the CMD/DATA/STATUS IRQ bit in the Status register (process 510). If CMD IRQ ENABLE is set in the Control register, storage device 114 also asserts IRQ* (process 512). Host system 112 reads the Status register to confirm that the CMD/DATA/STATUS interrupt occurred (process 514), and acknowledges the interrupt (whether enabled or not) by writing the Acknowledge Command/Data/Status Interrupt function code to the Control register (process 516).

Host system 112 then writes the command packet bytes to storage device 114 via the Data register (process 518). The byte count for the packet is the value host system 112 wrote into the Byte Count register prior to issuing the Start Command function.

Upon completion of the packet transfer, storage device 114 clears DATA and begins executing the command. Depending on the command and its parameters, storage device 114 may proceed to Status state 406, or Data state 410.

To initiate a read or write in Data state 410, storage device 114 places the number of bytes to transfer in the Byte Count register (process 520), clears CONTROL/DATA*, and sets RD/WR* (for Read Data phase) or clears RD/WR* (for Write Data phase). Storage device 114 then sets DATA and sets CMD/DATA/STATUS IRQ (process 510). If DATA IRQ ENABLE is set in the Control register, storage device 114 also asserts IRQ* (process 512).

Host system 112 reads the Status register to confirm that the CMD/DATA/STATUS interrupt occurred (process 514), and acknowledges the interrupt (whether enabled or not) by writing the Acknowledge Command/Data/Status Interrupt function code to the Control register (process 516). Host system 112 then reads the Status register to determine the new state (process 514), and reads the Byte Count register (process 521) to determine the number of bytes to transfer.

For a Read Data command, host system 112 reads the specified number of bytes from the Data register. For a Write Data command, host system 112 writes the specified number of bytes to the Data register.

Upon completion of the block transfer (process 522), storage device 114 clears DATA. Storage device 114 may then repeat this procedure for another Data phase, or may proceed to Status state 406.

It is not required that the bytes per block be the same for all Data phases within a command. Host system 112 reads the Byte Count register before each transfer to determine the size of the block.

To initiate Status state 406, storage device 114 sets CONTROL/DATA* and sets RD/WR* in the Status register. Storage device 114 then sets DATA (process 510) and sets the CMD/DATA/STATUS IRQ bit in the Status register. If STATUS IRQ ENABLE is set in the Control register, storage device 114 also asserts IRQ* (process 512).

Host system 112 reads the Status register to confirm that the CMD/DATA/STATUS interrupt occurred (process 514), and acknowledges the interrupt (whether enabled or not) by writing the Acknowledge Command/Data/Status Interrupt function code to the Control register (process 516).

Host system 112 then reads the Status register to determine the new state, and reads the Byte Count register to determine the number of bytes to transfer (process 508). Host system 112 reads the specified number of status bytes from the Data register (process 524).

Immediately upon completion of the status transfer (process 524), storage device 114 clears DATA and clears BUSY. Host system 112 need not poll to confirm the clearing of DATA and BUSY. Storage device 114 is now ready to accept a new command.

Asynchronous Events

Events may occur within host system 112 or storage device 114 that are asynchronous to normal command processing. When an event on host system 112 requires an interruption in command processing, host system 112 uses the Abort function to force storage device 114 to terminate the current command and return to its idle state.

Device events that require host system 112's attention (called attention events) often are due to user actions, such as inserting or removing storage media 130 in storage device 114. When storage device 114 determines that an attention event has occurred, it requests host system 112's attention by setting the ATTENTION IRQ bit in the Status register, and asserting IRQ* (if the ATTENTION IRQ ENABLE bit in the Control register is set).

Host system 112 may abort a currently active command by writing the Abort function code to the Control register. This function notifies storage device 114 to terminate the current command and return to a not busy state.

The Abort function has an effect on storage device 114 only when BUSY is set. If host system 112 issues the Abort function while BUSY is clear, it has no effect on storage device 114.

The ABORT procedure ends when storage device 114 clears BUSY in the Status register.

Host system 112 must abort its own data transfer before issuing the Abort to storage device 114. If host system 112 has a process actively transferring data to or from storage device 114 that continues after the Abort is sent to storage device 114, that process is unlikely to terminate successfully.

To avoid race conditions between the currently active command and the Abort function, host system 112 disables all device interrupts via the Control register before issuing the Abort function.

The following device events are examples that may require attention from host system 112.

a) The user may request storage media 130 to be ejected while idle, reading, or writing.

b) The user may insert storage media 130 into storage device 114.

c) The user may eject storage media 130 when it is not locked by host system 112.

These events cause device to set the ATTENTION IRQ bit in the Status register, and assert IRQ* (if the ATTENTION IRQ ENABLE bit in the Control register is set).

When host system 112 responds to the IRQ, it reads the Status register and sees the ATTENTION IRQ bit set. Host system 112 acknowledges the interrupt by writing the Acknowledge Attention Interrupt function code to the Control register.

If host system 112 chooses to get the attention information immediately, and a command is currently active, host system 112 aborts the active command. After the command is aborted, host system 112 may issue the commands required to determine the cause of the Attention. If host system 112 needs to continue an aborted data transfer, it manages the information to resume the command appropriately.

Power-On Sequences

In one embodiment, the present interface protocol includes power-on signals for proper interface initialization, as discussed in the following paragraphs.

When power is applied to storage device 114, it sets the BUSY bit in the Status register. Once storage device 114 has initialized and is ready to accept commands, it clears BUSY. At power-on, and while storage device 114 is still BUSY, Data and Byte Count registers are filled with a power-on signature, such as 0xAA and 0x55 respectively. This feature allows host system 112 to quickly determine the presence of a device without timeout polling or waiting for storage device 114 to clear BUSY. Once a write is done to any register, the power-on signature is no longer available. Writing the Enable Power-On signature function code to the Control register re-enables this feature.

The following power-on sequence is used to initialize storage device 114:

Write storage device Control register with the Enable Power-On Signature function code. This enables the signature response and aborts any active command, and can be done independent of storage device BUSY state.

Read the Data and Byte Count registers and check for the power-on signature.

Wait for BUSY to clear in the Status register before issuing a Start Command Function.

If the power-on signature is not found it implies storage device 114 is not present. After host system 112 has detected the power-on signature it can continue its own power-on initialization and check storage device BUSY when it is ready to send commands to storage device 114.

### ADVANTAGES

Advantageously, the present invention provides a byte-wide parallel, packet-based interface protocol that is independent of storage device's 114 characteristics and device specific commands. As a result, the interface does not require host system 112 to have any knowledge of storage device 114 or command parameters. This is an advantage over the prior art because prior art devices include registers with bit definitions and status signals that depend on the type of storage device 114 being utilized. The present invention advantageously provides an interface protocol that is independent of the storage device, and can be used between any type of host system 112 and storage device 114.

The present invention also provides a generic set of commands and command interface that is extensible for future expansion.

Another advantage is that the present invention provides a generic block data transfer protocol that is capable of transferring data blocks of all sizes, whereas data transfers in systems known in the prior art are accomplished in fixed block sizes.

A further advantage is that the present invention provides an asynchronous notification method that allows both host system 112 and storage device 114 to affect the normal command flow due to external events.

Further, the present invention provides an interface protocol that can connect directly to host bus 118, allowing simple, low cost connections.

The present invention also allows host drivers to utilize either interrupts or polling, as dictated by host system 112 requirements. Host processor 116 can be interrupted using the IRQ* signal as an interrupt within itself. When the IRQ* interrupt occurs, host processor 116 can read the storage device Status register to determine the cause of the interrupt event. Alternatively, host processor 116 can be polling based by periodically reading the storage device Status register to detect new events.

While the invention has been described with respect to the embodiments and variations set forth above, these embodiments and variations are illustrative and the invention is not to be considered limited in scope to these embodiments and variations. For example, the interface protocol may be utilized on both serial and parallel bus structures. Further, the interface protocol of the present invention may be used with a variety of storage devices that may not include control, data, and status registers as described herein. One alternative to delivering packets to respective registers is to place a header on the packets and including facilities in storage device controller 146 to decode the header and determine the type of information included in the packet. Storage device controller 146 then handles the information appropriately, based on the contents of the header. Accordingly, various other embodiments and modifications and improvements not described herein may be within the spirit and scope of the present invention, as defined by the following claims.

What is claimed is:

1. A system for transmitting packets between a host system and a storage device, wherein the storage device includes one or more special purpose registers and each packet includes at least command, data, or status information, the system comprising:
a data signal for transmitting data between the host system and the storage device;
a plurality of address signals for selecting the registers based on whether the packet includes command, data, or status information;
an enable signal for allowing the packets to be transmitted to and from the storage device;
a read strobe signal; and
a write strobe signal.

2. The system of claim 1 wherein the packets may vary in length.

3. The system of claim 1 wherein the registers include a data register.

4. The system of claim 1 wherein the registers include a control register.

5. The system of claim 4 wherein the control register includes a function code signal and at least one interrupt request enable signal.

6. The system of claim 5 wherein the control register includes a start command function code.

7. The system of claim 5 wherein the control register includes an abort function code.

8. The system of claim 5 wherein the control register includes an enable power-on signature function code.

9. The system of claim 5 wherein the control register includes an acknowledge interrupt function code.

10. The system of claim 4 wherein the control register includes a data interrupt request enable signal.

11. The system of claim 4 wherein the control register includes a status interrupt request enable signal.

12. The system of claim 1 wherein the registers include a status register.

13. The system of claim 12 wherein the status register includes signals to indicate when the storage device is busy, ready to transfer data, to receive bytes from a command packet, to receive or transmit a data block, to transmit status bytes, and to transfer control information or data.

14. The system of claim 12 wherein the status register includes a signal to indicate that an asynchronous event occurred that requires the attention of the host system.

15. The system of claim 14 wherein the asynchronous event is a storage device attention event including a request for storage media in the storage device to be ejected, or storage media is inserted in the storage device.

16. The system of claim 12 wherein the status register includes power-on support for indicating when the storage device is ready.

17. A method for transmitting data between a host system and a storage device using an asynchronous interface protocol, the method comprising:
issuing an abort function before issuing a command packet if the storage device is busy;
transmitting a packet including the size of the next command packet to be transmitted and a start command function code from the host system to the storage device;
setting the storage device busy signal;
determining if the size of the next command packet is within the maximum command packet size supported by the storage device;
issuing an error signal if the next command packet is greater than the maximum command packet size supported by the storage device.

18. The method of claim 17 further comprising:
setting a control/data/status interrupt signal;
transmitting the command packet to the data register if the control/data/status interrupt signal is set; and
executing the command in the command packet.

19. The method of claim 18 wherein executing a write command comprises:
placing the number of bytes to transfer in a data register in the storage device;
setting a write data signal;
setting a command/data/status interrupt request in the storage device;
acknowledging the interrupt in the host system; and
transferring the specified number of bytes from the host system to the storage device.

20. The method of claim 18 wherein executing a read command comprises:
placing the number of bytes to transfer in a data register in the storage device;
setting a read data signal;
setting a command/data/status interrupt request in the storage device;
acknowledging the interrupt in the host system; and
transferring the specified number of bytes from the storage device to the host system.

21. The method of claim 18 further comprising:
setting a status signal;
issuing an interrupt to the host system
checking the status in the host system;
using the status to determine whether the storage device is ready to accept another command packet.

22. The method of claim 18 further comprising:
interrupting command processing in the storage device to respond to asynchronous events issued from the host system.

23. The method of claim 18 wherein the asynchronous event is a device attention event.

24. The method of claim 18 wherein the asynchronous event is an abort signal issued by the host system.

25. The method of claim 18 further comprising:
issuing a busy signal during power-on until the storage device is ready to accept packets from the host system.

26. The method of claim 25 wherein the storage device enters a power-on signature in a special-purpose register before power-on is complete.

27. An interface protocol for transmitting variable-sized packets between a host system and a storage device, the interface protocol comprising:
a plurality of parallel data signals for transmitting data between the host system and the storage device;
a plurality of address signals for indicating whether the packet includes command, data, or status information;
an enable signal for indicating when the packets may be transmitted to and from the storage device;
a read strobe signal; and
a write strobe signal.

28. The interface protocol of claim 27 wherein the packet includes a function code and at least one interrupt request.

29. The interface protocol of claim 27 further comprising a signal to indicate when the storage device is busy.

30. The interface protocol of claim 27 further comprising a signal to indicate when the storage device is ready to transfer data.

31. The interface protocol of claim 27 further comprising a signal to indicate when the storage device is ready to receive bytes from a command packet.

32. The interface protocol of claim 27 further comprising a signal to indicate when the storage device is ready to receive or transmit a data block.

33. The interface protocol of claim 27 further comprising a signal to indicate when the storage device is ready to transmit status bytes.

34. The interface protocol of claim 27 further comprising a signal to indicate that an asynchronous event occurred that requires the attention of the host system.

35. The interface protocol of claim 34 wherein the asynchronous event is an abort function code input to the storage device from the host system.

36. The interface protocol of claim 34 wherein the asynchronous event is a storage device attention event including a request for ejecting or inserting storage media in the storage device.

37. The interface protocol of claim 34 wherein the status register includes power-on support for indicating when the storage device is ready.

38. An interface protocol for communicating packets of information between a host system and a storage device, the interface protocol comprising:
a status signal to indicate the state of the storage device;
a start command signal to initiate processing of a command in the storage device;
a command packet size signal to indicate the amount of data to be transferred between the host system and the storage device, wherein the packet size can vary between packets; and
a plurality of command signals for accessing information on the storage device.

39. The interface protocol of claim 38 further comprising:
an interrupt request signal; and
an interrupt acknowledge signal.

40. The interface protocol of claim 38 further comprising:
a status signal to indicate whether an interrupt signal was generated by the storage device.

41. The interface protocol of claim 38 further comprising:
a status signal to indicate whether an error occurred while the storage device was performing a command.

42. The interface protocol of claim 38 further comprising a signal to indicate when the storage device is ready to transfer data.

43. The interface protocol of claim 38 further comprising a signal to indicate when the storage device is ready to receive bytes from a command packet.

44. The interface protocol of claim 38 further comprising a signal to indicate when the storage device is ready to receive or transmit a data block.

45. The interface protocol of claim 38 further comprising a signal to indicate when the storage device is ready to transmit status bytes.

46. The interface protocol of claim 38 further comprising a signal to indicate that an asynchronous event occurred.

47. The interface protocol of claim 46 wherein the asynchronous event is a storage device attention event including a request for ejecting or inserting storage media in the storage device.

48. The interface protocol of claim 38 further comprising a start command function code.

49. The interface protocol of claim 38 further comprising an abort function code.

50. The interface protocol of claim 38 further comprising an enable power-on signature function code.

51. The interface protocol of claim 38 further comprising an acknowledge interrupt function code.

52. The interface protocol of claim 38 further comprising a data interrupt request enable signal.

53. The interface protocol of claim 38 further comprising a status interrupt request enable signal.
